(19) United States
(12) Patent Application Publication
(10) Pub. No.: US 2023/0120548 A1
(43) Pub. Date: Apr. 20, 2023

(54) SECRET CALCULATION SYSTEM, SECRET CALCULATION METHOD, AND PROGRAM

(71) Applicant: Nomura Research Institute, Ltd., Tokyo (JP)

(72) Inventors: Yasunori HOKAZONO, Tokyo (JP); Koutarou TAMURA, Tokyo (JP)

(21) Appl. No.: 18/083,683

(22) Filed: Dec. 19, 2022

Related U.S. Application Data
(63) Continuation of application No. PCT/JP2021/027019, filed on Jul. 19, 2021.

(30) Foreign Application Priority Data
Jul. 22, 2020 (JP) 2020-125547

(51) Int. Cl. G09C 1/00; G06F 21/60

(52) U.S. Cl. CPC G09C 1/00; G06F 21/60

(57) ABSTRACT

A secret calculation system is a secret calculation system that executes secret calculation for calculating data in an encrypted state, and includes a first acquisition unit that acquires first data encrypted, a second acquisition unit that acquires second data unencrypted according to the first data, a secret calculation unit that executes the secret calculation on the basis of the first data and the second data, and an output unit that outputs a result of the secret calculation in an encrypted state. As a result, it is possible to improve data security and reduce a processing load on the secret calculation.

### BACKGROUND

### Technical Field

The present invention relates to a secret calculation system, a secret calculation method, and a program.

### Related Art

Conventionally, there has been known a secret distribution method, which is one of secret calculation techniques and is a method with which secret information is distributed into a plurality of groups and various processes are executed by the groups cooperating with each other.

For example, JP 2005-234069 A describes a secret distribution processing system that ensures validity of distributed data by adding verification data to the distributed data and performing evaluation using the distributed data and the verification data before restoration.

### SUMMARY

However, the conventional secret calculation technique described in JP 2005-234069 A is not necessarily for reducing the processing load on secret calculation.

Therefore, some aspects of the present invention have been made in view of such circumstances, and an object of the present invention is to provide a secret calculation technique capable of improving the security of data and reducing the processing load on the secret calculation.

A secret calculation system according to an aspect of the present invention is a secret calculation system that executes secret calculation for calculating data in an encrypted state, and includes a first acquisition unit that acquires encrypted first data, a second acquisition unit that acquires unencrypted second data according to the first data, a secret calculation unit that executes the secret calculation on the basis of the first data and the second data, and an output unit that outputs a result of the secret calculation in an encrypted state.

A secret calculation method according to an aspect of the present invention is a secret calculation method causing a computer to execute secret calculation for calculating data in an encrypted state, and includes acquiring encrypted first data, acquiring unencrypted second data according to the first data, executing the secret calculation on the basis of the first data and the second data, and outputting a result of the secret calculation in an encrypted state.

A program according to an aspect of the present invention causes a computer that executes secret calculation for calculating data in an encrypted state to function as a first acquisition unit that acquires first data encrypted, a second acquisition unit that acquires second data unencrypted according to the first data, a secret calculation unit that executes the secret calculation on the basis of the first data and the second data, and an output unit that outputs a result of the secret calculation in an encrypted state.

In the present invention, a “unit” does not simply mean a physical means, and comprehends a case where a function of the “unit” is implemented by software. A function of one “unit” or device may be implemented by two or more physical units or devices, or functions of two or more “units” or devices may be implemented by one physical unit or device.

According to the present invention, it is possible to improve the security of data and reduce a processing load on the secret calculation.

### BRIEF DESCRIPTION OF DRAWINGS

FIG. 1 is a schematic configuration diagram (system configuration diagram) illustrating an example of a secret calculation system that calculates data in an encrypted state according to an embodiment;

FIGS. 2A and 2B are diagrams illustrating an example of stock number data and stock price data according to an embodiment; FIG. 2A is a diagram illustrating an example of the stock number data; FIG. 2B is a diagram illustrating an example of the stock price data;

FIG. 3 illustrates an example of a functional configuration diagram of a secret calculation server device according to an embodiment;

FIG. 4 is a flowchart of a first example of secret calculation processing according to an embodiment;

FIGS. 5A to 5C are conceptual diagrams illustrating an example of encrypted data in the first example of the secret calculation processing according to an embodiment; FIG. 5A is a conceptual diagram illustrating an example of encrypted data in a secret calculation server device 1A illustrated in FIG. 1; FIG. 5B is a conceptual diagram illustrating an example of encrypted data in a secret calculation server device 1B illustrated in FIG. 1; FIG. 5C is a conceptual diagram illustrating an example of encrypted data in a secret calculation server device 1C illustrated in FIG. 1;

FIG. 6 is a flowchart of a second example of the secret calculation processing according to an embodiment;

FIGS. 7A to 7D are conceptual diagrams illustrating an example of encrypted data in the second example of the secret calculation processing according to an embodiment; FIG. 7A is a conceptual diagram illustrating an example of book value data (T−1); FIG. 7B is a conceptual diagram illustrating an example of transaction data (T); FIG. 7C is a conceptual diagram illustrating an example of trading balance data (T); FIG. 7D is a conceptual diagram illustrating an example of book value data (T);

FIG. 8 is a diagram illustrating an example of a hardware configuration of a computer according to an embodiment; and

FIG. 9 is a schematic configuration diagram illustrating another example of the secret calculation system according to an embodiment.

### DETAILED DESCRIPTION

An embodiment of the present invention will be described with reference to the accompanying drawings. Note that the following embodiment is an example for describing the present invention and is not intended to limit the present invention only to the embodiment. In addition, the present invention can be made into various modifications as long as the modifications do not depart from the gist of the invention. Furthermore, in each drawing, the same components are denoted by the same reference numerals as much as possible, and redundant description are omitted.

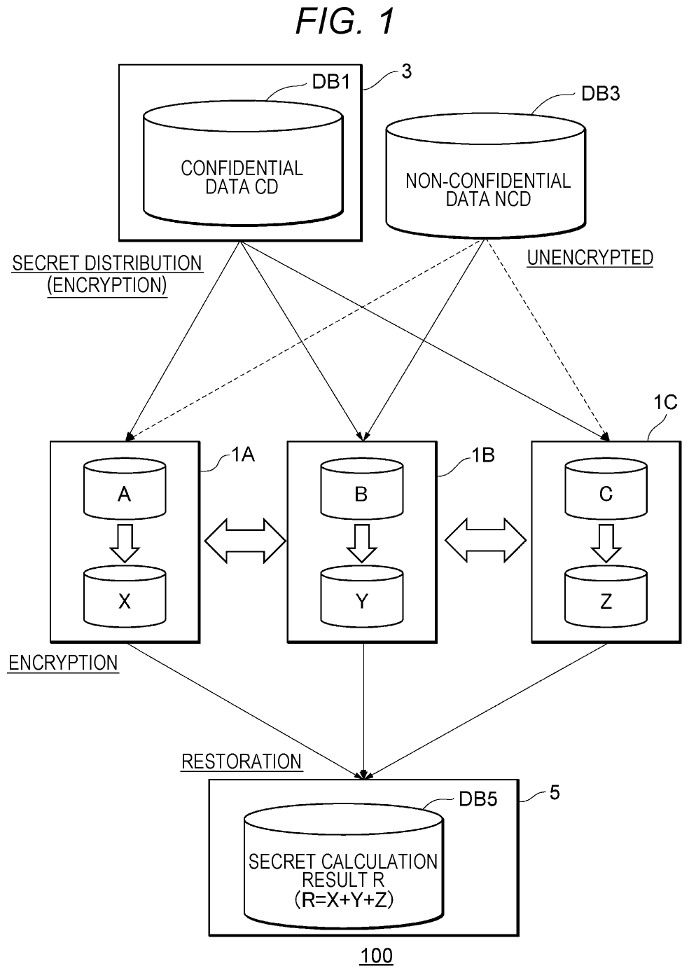

FIG. 1 is a schematic configuration diagram (system configuration diagram) illustrating an example of a secret calculation system that executes secret calculation for calculating data in an encrypted state according to an embodiment. The “secret calculation” means calculation processing performed in a state where data is confidential. In the “secret calculation”, for example, desired calculation processing is executed without disclosing the data that one or a plurality of organizations hold to the organizations or another organization at all. In addition, in the “secret calculation”, a calculation result is provided in a confident state to one or a plurality of organizations or to another organization that needs the calculation result. As described above, in the “secret calculation”, the security of confidential data CD (first data) to be kept confidential is improved. Furthermore, in the “secret calculation”, the process of secret calculation is also confidential, so that the security of the process of secret calculation is improved.

As illustrated in FIG. 1, the secret calculation system 100 as an example includes secret calculation server devices 1A, 1B, and 1C (server devices), a confidential data supply device 3, and a calculation result restoration device 5. When the secret calculation server devices 1A, 1B, and 1C are not distinguished from each other, they are referred to as the “secret calculation server device 1”. The secret calculation system 100 according to the present embodiment calculates, for example, an appraised value of one or a plurality of stocks included in an investment trust and a standard value (value per unit) based on the appraised value by using the secret calculation. Hereinafter financial products constituting an investment trust may include other financial products such as a bond and real property in addition to stocks.

The confidential data supply device 3 includes a database (DB) 1 storing the confidential data CD, and supplies the confidential data CD in an encrypted state to each of the secret calculation server devices 1A, 1B, and 1C. In addition, from the database (DB) 3 in which non-confidential data NCD (second data) is managed, the non-confidential data NCD is supplied in an unencrypted state to each of the secret calculation server devices 1A, 1B, and 1C. The confidential data CD is data to be kept confidential, and is data that needs to be prevented from being known to a third party, as described later. In addition, the non-confidential data NCD is data that has no problem even if it is known to a third party. In FIG. 1, the DB3 in which the non-confidential data NCD is managed is explained as a component separate from the secret calculation server device 1, but the secret calculation server device 1 may include the DB3.

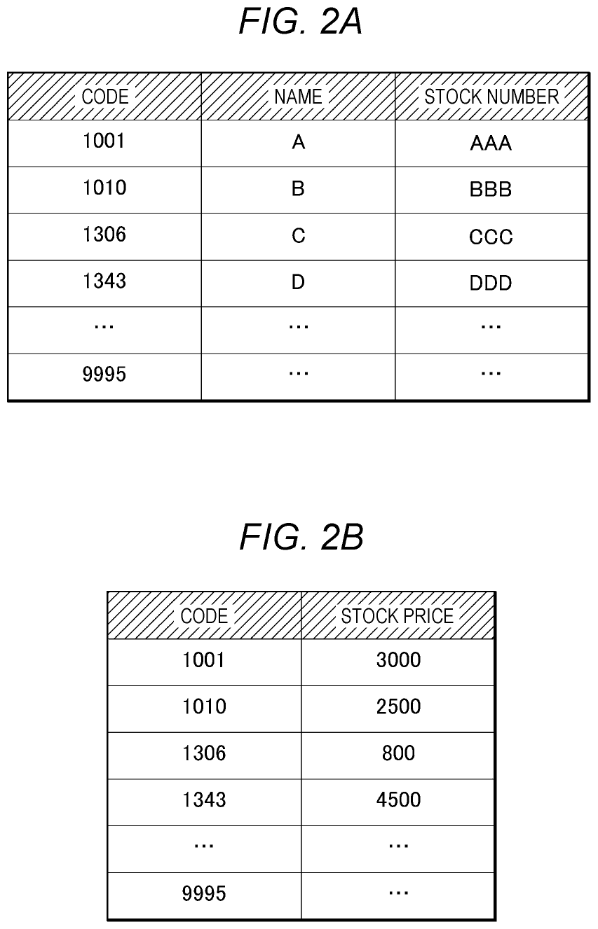

FIG. 2A is a diagram illustrating stock number data (holding number data) regarding the number of stocks held by a manager of stocks (financial products), which is an example of the confidential data. As illustrated in FIG. 2A, the stock number data includes a brand code, a name, and the number of stocks. At least the name of stocks and the numbers of stocks in the stock number data are encrypted when supplied to the secret calculation server devices 1A, 1B, and 1C. This is because it is necessary for the manager to avoid the name and the number of stocks held by the manager from being known to a third party including other managers. That is, this is to prevent leakage of the trading strategy or the trading algorithm for the stocks of the manager.

FIG. 2B is a diagram illustrating stock price data (price data) regarding the price of a stock (financial product), which is an example of the non-confidential data. As illustrated in FIG. 2B, the stock price data includes a brand code and a stock price. The stock price data may further include a stock name.

In the present embodiment, the secret calculation system 100 executes “secret distribution” processing in the “secret calculation”. The “secret distribution” is a technique that secures confidentiality of data by dividing the data into a plurality of fragments that are called “shares” and performing the secret calculation. As illustrated in FIG. 1, in the secret calculation system 100 that executes the secret distribution, the confidential data supply device 3 divides the confidential data CD and transmits the divided pieces of the confidential data CD as shares A, B, and C in an encrypted state to the respective secret calculation server devices 1A, 1B, and 1C. Each of the shares A, B, and C has a relationship between a ciphertext and a key in a case of a general encryption technology, and this relationship is used when a secret calculation result is restored. Note that the shares A, B, and C are, for example, predetermined random numbers.

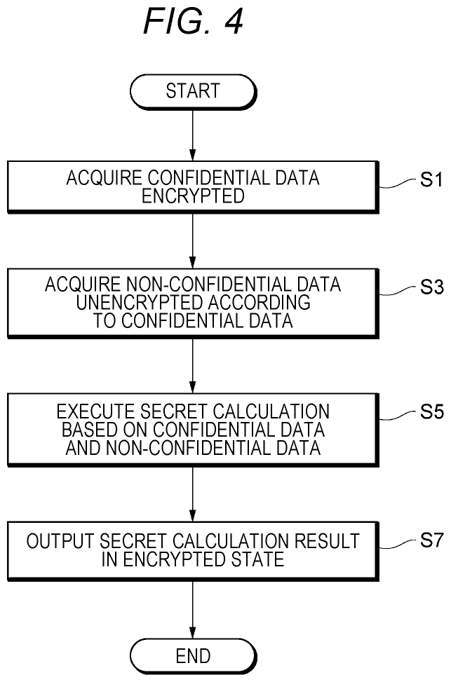

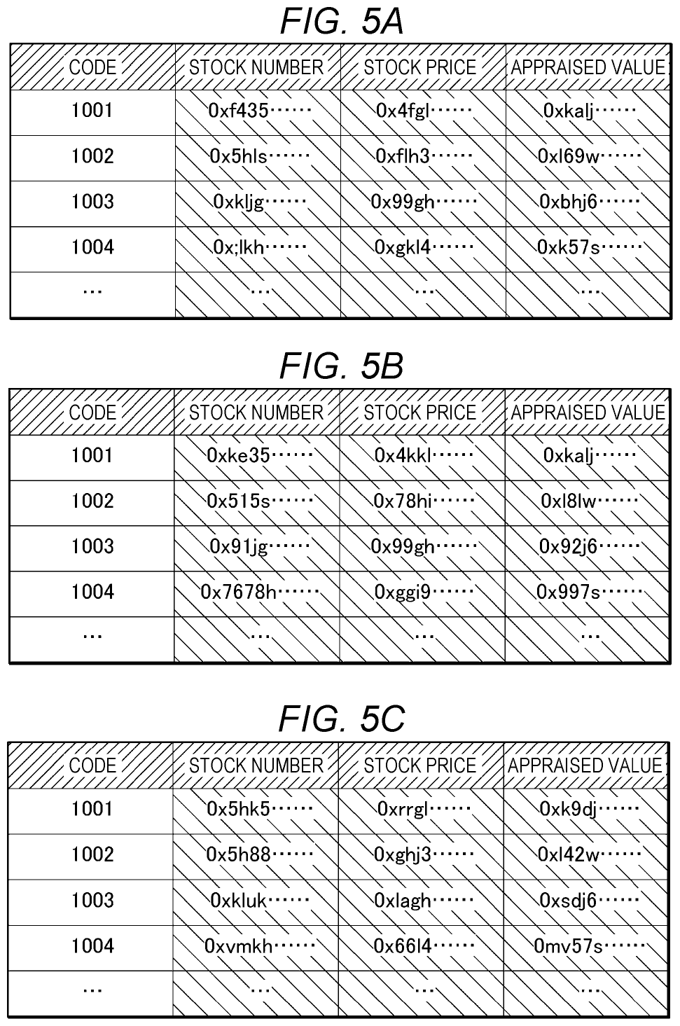

The secret calculation server device 1 is a device that executes the secret calculation. The secret calculation server devices 1A, 1B, and 1C can communicate with (cooperate with) each other. The secret calculation server devices 1A, 1B, and 1C execute the secret calculation on the basis of the shares A, B, and C and the non-confidential data NCD to calculate a secret calculation result (X, Y, Z). The secret calculation server devices 1A, 1B, and 1C output the secret calculation result (X, Y, Z) in an encrypted state to the calculation result restoration device 5. Note that specific contents of the secret calculation will be described in detail with reference to FIGS. 4 and 5A to 5C described later.

The calculation result restoration device 5 restores the calculation result by using a secret calculation result (X), a secret calculation result (Y), and a secret calculation result (Z) received from the secret calculation server devices 1A, 1B, and 1C, respectively. The calculation result restoration device 5 stores a secret calculation result R in a database (DB) 5.

Conventionally, encrypting and managing all enormous data (including non-confidential data) used for the secret calculation and performing calculation processing using all of the data introduce a large load on data processing. In the secret calculation system 100 according to the present embodiment, not all data to be subjected to the secret calculation processing is acquired as encrypted data, but data that does not need to be kept confidential is managed without being encrypted. When executing the secret calculation, the secret calculation system 100 refers to the brand code or the like to acquire non-confidential data (for example, stock price data) corresponding to confidential data (for example, stock number data) and executes the secret calculation. Therefore, it is possible to improve the security of confidential data and reduce the processing load on the secret calculation (for example, calculation processing speed is increased or calculation time is reduced).

In addition, in the secret calculation system 100, since the secret calculation is executed while the confidential data such as the name and the number of stocks held by the manager of the investment trust is kept confidential, it is possible to continue the management service with the privacy of the management situation maintained.

Furthermore, by adopting secret distribution processing in the secret calculation system 100, even in a case where a share is leaked from one secret calculation server device, it is difficult to restore (decode) the processing result. Therefore, since the secret of the confidential data is maintained, the security of confidential data is further improved.

Note that the secret calculation server device 1, the confidential data supply device 3, and the calculation result restoration device 5 are, for example, information processing devices such as a server device. The secret calculation server device 1, the confidential data supply device 3, and the calculation result restoration device 5 may be, for example, information processing devices such as a general-purpose personal computer, a smartphone, and a tablet terminal. In addition, the number of the secret calculation server device 1, the confidential data supply device 3, and the calculation result restoration device 5 is not limited.

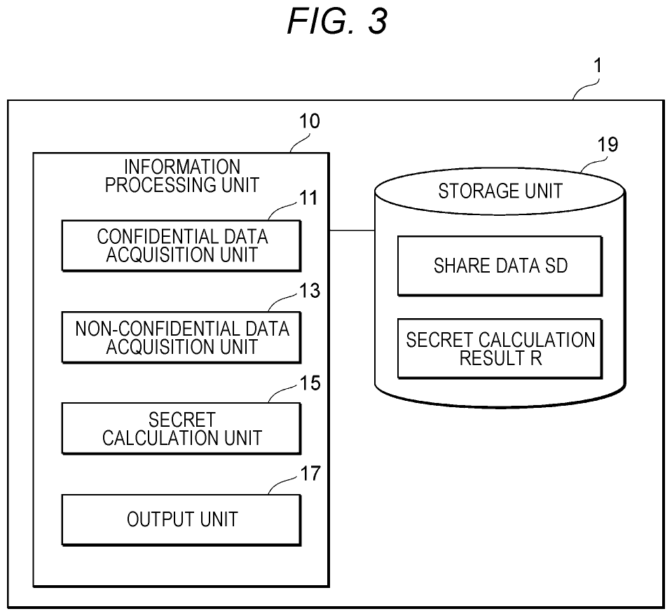

FIG. 3 illustrates an example of a functional configuration diagram of a secret calculation server device according to an embodiment. As illustrated in FIG. 3, the secret calculation server device 1 includes, for example, an information processing unit 10 that executes the secret calculation, and a storage unit 19 that stores data used at the time of executing the secret calculation or data regarding the result of the secret calculation.

The information processing unit 10 functionally includes, for example, a confidential data acquisition unit 11 (first data acquisition unit), a non-confidential data acquisition unit 13 (second data acquisition unit), a secret calculation unit 15, and an output unit 17. Note that the above-described units of the information processing unit 10 can be implemented, for example, by using a storage area such as a memory or a hard disk, or by causing a processor to execute a program stored in the storage area.

The confidential data acquisition unit 11 acquires confidential data encrypted. For example, the confidential data acquisition unit 11 acquires the shares that are generated by dividing the confidential data CD, in an encrypted state from the confidential data supply device 3 illustrated in FIG. 1.

The non-confidential data acquisition unit 13 acquires non-confidential data unencrypted according to confidential data. For example, the non-confidential data acquisition unit 13 acquires the non-confidential data NCD according to the shares of the confidential data CD acquired from the confidential data supply device 3 illustrated in FIG. 1. More specifically, the non-confidential data acquisition unit 13 refers to the brand code included in the stock number data illustrated in FIGS. 2A and 2B, and acquires the stock price of the stock corresponding to the aforementioned code from the DB3 in which the non-confidential data NCD is managed.

The secret calculation unit 15 executes secret calculation on the basis of the confidential data and the non-confidential data. For example, the secret calculation unit 15 executes the secret calculation on the basis of share data regarding the stock number data and the stock price data stored in the storage unit 19, and calculates the appraised value of a stock. The appraised value of the stock is calculated by multiplying the number of stocks and the stock price for each brand. With this configuration, it is possible to calculate the appraised value of the stock with the confidential information such as the number of stocks of the manager kept confidential.

The output unit 17 outputs the result of the secret calculation in an encrypted state. For example, as illustrated in FIG. 1, the output unit 17 outputs the calculation result (X, Y, or Z) regarding the appraised value of the stock in an encrypted state to the calculation result restoration device 5. The output unit 17 may output the calculation result in an encrypted state to the confidential data supply device 3.

The storage unit 19 stores, for example, share data SD regarding shares that are fragments of the confidential data and are generated by the secret distribution on the confidential data, and a secret calculation result R of the secret calculation unit 15.

<Secret calculation processing>

(First example)

A first example of the secret calculation processing according to an embodiment will be described with reference to FIGS. 4 and 5A to 5C. In the first example, the secret calculation server device 1 calculates the appraised value of one or a plurality of stocks by the secret calculation processing.

FIG. 4 is a flowchart of the first example of the secret calculation processing according to an embodiment. First, as a premise, in the secret calculation processing, the secret calculation processing application software according to an embodiment of the present invention is downloaded, for example, from a predetermined site on a network or from a recording medium, and is stored in the secret calculation server device 1 illustrated in FIG. 1 so as to be executable. Then, when execution of the secret calculation processing application software is instructed, a program operation based on the software starts. Note that the confidential data supply device 3 and the calculation result restoration device 5 also execute the software in advance so as to appropriately operate as the elements of the secret calculation system 100.

(Step S1)

The secret calculation server device 1 illustrated in FIG. 1 acquires confidential data encrypted. For example, the secret calculation server device 1 acquires encrypted stock number data of all brands from the confidential data supply device 3 illustrated in FIG. 1. According to this configuration, since the stock number data of all brands is transmitted to the secret calculation server device 1 regardless of whether or not the investment trust manager holds the stock, the data management of the confidential data supply device 3 becomes simple.

(Step S3)

The secret calculation server device 1 acquires non-confidential data unencrypted according to confidential data. For example, the secret calculation server device 1 acquires stock price data of a brand for which the number of stocks held by the manager is other than “zero” among stock price data of all brands by referring to the brand code.

(Step S5)

The secret calculation server device 1 executes the secret calculation on the basis of the confidential data and the non-confidential data. For example, the secret calculation server device 1 calculates an appraised value in an encrypted state on the basis of the acquired stock number data and the acquired stock price data.

FIGS. 5A to 5C are conceptual diagrams illustrating an example of encrypted data in the first example of the secret calculation processing according to an embodiment. FIG. 5A is a conceptual diagram illustrating an example of encrypted data in a secret calculation server device 1A illustrated in FIG. 1. FIG. 5B is a conceptual diagram illustrating an example of encrypted data in a secret calculation server device 1B illustrated in FIG. 1. FIG. 5C is a conceptual diagram illustrating an example of encrypted data in a secret calculation server device 1C illustrated in FIG. 1. As illustrated in FIGS. 5A to 5C, in each of the secret calculation server devices 1A, 1B, and 1C, the secret calculation is executed in a state, for example, where data other than the brand code, that is, the stock number data, the stock price data, and the appraised value data are encrypted. In addition, each of the secret calculation server devices 1A, 1B, and 1C may execute the secret calculation after encrypting the brand code.

(Step S7)

The secret calculation server device 1 outputs the secret calculation result in an encrypted state.

As described above, according to the first example of the secret calculation processing, the secret calculation server device 1 acquires stock number data encrypted, and acquires stock price data unencrypted according to the stock number data. The secret calculation server device 1 calculates the appraised value of the stock in an encrypted state on the basis of the stock number data and the stock price data, and outputs the secret calculation result in an encrypted state. Therefore, it is possible to improve the security of confidential data and reduce a processing load on the secret calculation.

(Second example)

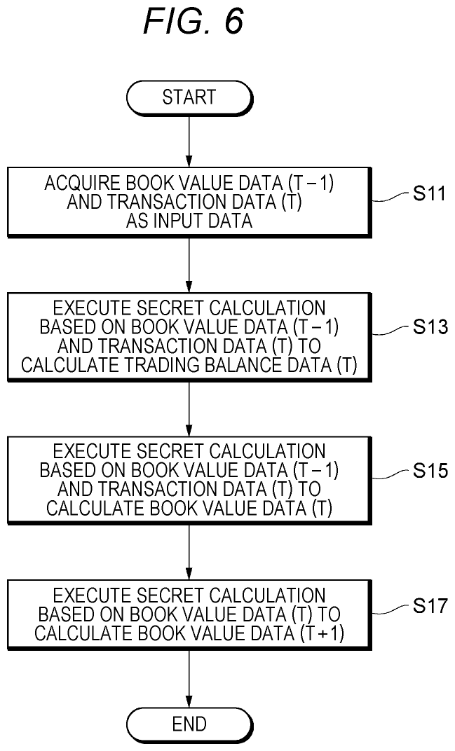

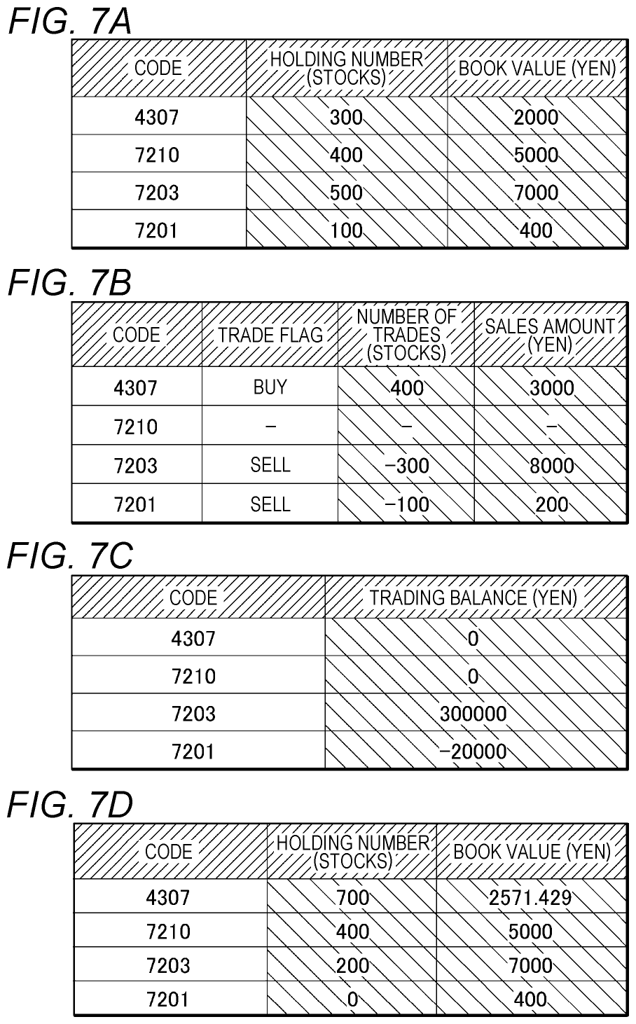

A second example of the secret calculation processing according to an embodiment will be described with reference to FIGS. 6 and 7A to 7D. In the second example, the secret calculation server device 1 calculates the standard value of an investment trust constituted by one or a plurality of stocks using the appraised value of one or a plurality of stocks calculated in the first example. The second example is similar to the first example in that the secrecy of data to be kept confidential is maintained, by using the secret calculation in the process of calculating the standard value.

The standard value of the investment trust is obtained by dividing the net asset value by the total number of units of the investment trust (total number of units of beneficial interest). The standard value of the investment trust is expressed as the following equation 1.

Standard value=Net asset value/Total number of units . . . (1)

The net asset value is expressed by the following equation 2 using the total appraised value of stocks, the balance to be carried forward, and others (accounts payable, accounts receivable, call loans, and the like).

Net asset value=Total appraised value of stocks+Balance to be carried forward+Others . . . (2)

The total appraised value of stocks is the sum of the appraised values of all stocks held. Note that, as described above, the appraised value of the stocks is calculated by multiplying the number of stocks and the stock price for each brand. Hereinafter, as an example, a method of calculating balance to be carried forward will be described with reference to FIGS. 6 and 7A to 7D.

FIG. 6 is a flowchart illustrating the second example of the secret calculation processing according to an embodiment. FIGS. 7A to 7D are conceptual diagrams illustrating an example of encrypted data in the second example of the secret calculation processing according to an embodiment. FIG. 7A is a conceptual diagram illustrating an example of book value data (T−1) of stocks (financial products). FIG. 7B is a conceptual diagram illustrating an example of transaction data (T) of stocks. FIG. 7C is a conceptual diagram illustrating an example of trading balance data (T) of stocks. FIG. 7D is a conceptual diagram illustrating an example of book value data (T) of stocks. Note that FIGS. 7A to 7D illustrate each data for convenience of description, but grayed out data is encrypted in the process of secret calculation. That is, at least the number of stocks held and the book value in FIG. 7A, the number of stocks traded and the sales amount in FIG. 7B, the balance on sale of the stocks in FIG. 7C, and the number of stocks held and the book value in FIG. 7D are encrypted in the process of secret calculation. In addition, the trade flag in FIG. 7B may also be encrypted.

(Step S11)

The secret calculation server device 1 illustrated in FIG. 1 acquires the book value data (T−1) illustrated in FIG. 7A and the transaction data (T) illustrated in FIG. 7B as input data.

(Step S13)

The secret calculation server device 1 illustrated in FIG. 1 executes the secret calculation on the basis of the book value data (T−1) and the transaction data (T) to calculate the trading balance data (T). For example, when the number of stocks traded is “(+) 400” as in the stock with the brand code “4307” illustrated in FIG. 7B, the “trade flag” is “purchased”, and when the number of stocks traded is “−300” as in the stock with the brand code “7203”, the “trade flag” is “sold”.

Regarding the calculation of the trading balance data (T), in a case where the trade flag is “purchased”, the trading balance is “0”, and in a case where the trade flag is “sold”, the trading balance is expressed by the following equation 3. The calculation of the equation 3 is also performed in the secret calculation.

Trading balance (T)=(Book value (T−1)−Sales amount)×Number of stocks traded . . . (3)

As illustrated in FIG. 7C, the balance to be carried forward corresponds to an amount obtained by adding up the balance of each brand.

(Step S15)

The secret calculation server device 1 illustrated in FIG. 1 executes the secret calculation on the basis of the book value data (T−1) and the transaction data (T) to calculate the book value data (T). For example, the holding number (T) and the book value (T) illustrated in FIG. 7D are expressed by the following equation 4. Note that the calculation of the equation 4 is also performed in the secret calculation.

Holding number (T)=Holding number (T−1)+Number of stocks traded . . . (4)

More specifically, for the holding number (T) of the stocks with the brand code “4307”, the holding number (T) “700” illustrated in FIG. 7D is calculated by adding the number of stocks traded “300” illustrated in FIG. 7B to the holding number (T−1) “400” illustrated in FIG. 7A.

The book value (T) illustrated in FIG. 7D is expressed by the following equation 5. Note that the calculation of the equation 5 is also performed in the secret calculation.

Book value (T)={Holding number (T−1)×Book value (T−1)+Number of stocks traded×Sales amount}/Holding number (T) . . . (5)

More specifically, the book value (T) of the brand code “4307” is calculated as “2571.429” on the basis of the holding number (T−1) “400” and the book value (T−1) “2000” illustrated in FIG. 7A, the number of stocks traded “300” and the sales amount “3000” illustrated in FIG. 7B, and the holding number (T) “700” illustrated in FIG. 7D.

(Step S17)

The secret calculation server device 1 illustrated in FIG. 1 executes the secret calculation on the basis of the book value data (T) to calculate the book value data (T+1). The secret calculation server device 1 can use the book value data (T+1) when calculating the balance to be carried forward at next time.

As described above, according to the second example of the secret calculation processing, the secret calculation server device 1 calculates the trading balance data on the basis of the book value data of one or a plurality of stocks and the transaction data of one or a plurality of stocks by using the secret calculation. The secret calculation server device 1 calculates the standard value of the investment trust on the basis of the trading balance data calculated and the appraised value of the stocks calculated. Therefore, even when calculating the standard value of an investment trust constituted by one or a plurality of stocks by the secret calculation, it is possible to improve the security of the confidential data and reduce the processing load on the secret calculation.

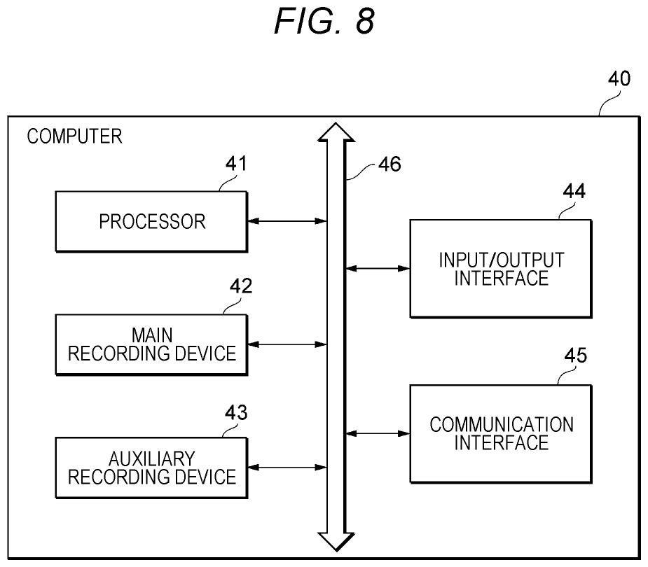

FIG. 8 is a diagram illustrating an example of a hardware configuration of a computer according to an embodiment. An example of a hardware configuration of a computer that can be used to configure various devices in the secret calculation system 100 illustrated in FIG. 1, for example, the secret calculation server device 1, the confidential data supply device 3, and the calculation result restoration device 5 will be described with reference to FIG. 8.

As illustrated in FIG. 8, a computer 40 mainly includes, as hardware resources, a processor 41, a main recording device 42, an auxiliary recording device 43, an input/output interface 44, and a communication interface 45, which are connected to each other through a bus line 46 including an address bus, a data bus, a control bus, and the like. Note that an interface circuit (not illustrated) may be appropriately interposed between the bus line 46 and each hardware resource.

The processor 41 controls the entire computer. The processor 41 corresponds to, for example, the information processing unit 10 of the secret calculation server device 1 illustrated in FIG. 3. The main recording device 42 provides a work area for the processor 41, and is a volatile memory such as a static random access memory (SRAM) or a dynamic random access memory (DRAM). The auxiliary recording device 43 is a non-volatile memory such as an HDD, an SSD, and a flash memory, storing a program or the like as software and data or the like. The program, data, and the like are loaded from the auxiliary recording device 43 to the main recording device 42 through the bus line 46 at an arbitrary time point. The auxiliary recording device 43 corresponds to, for example, the storage unit 19 of the secret calculation server device 1 illustrated in FIG. 3.

The input/output interface 44 performs one or both of presenting information and receiving input of information, and is a camera, a keyboard, a mouse, a display, a touch panel display, a microphone, a speaker, a temperature sensor, and the like. The communication interface 45 transmits and receives data to and from various database (DB) 3, DB5, and DB7 illustrated in FIG. 1 through a predetermined communication network (not illustrated). The communication interface 45 and a predetermined communication network can be connected in a wired or wireless manner. The communication interface 45 may also acquire information related to a network, for example, information related to an access point of Wi-Fi, information related to a base station of a communication carrier, and the like.

It will be apparent to those skilled in the art that the cooperation of the above exemplified hardware resources and software enables the computer 40 to function as a desired means, perform a desired step, and implement a desired function.

Note that, the embodiment described above is for facilitating understanding of the present invention and is not intended to limit the present invention. The present invention can be modified and improved without departing from the gist of the invention, and equivalents thereof are also included in the present invention. In addition, the present invention can form various disclosures by appropriately combining a plurality of components disclosed in the embodiment described above. For example, some components may be deleted from all the components disclosed in the embodiment. Furthermore, the components may be appropriately combined with a different embodiment.

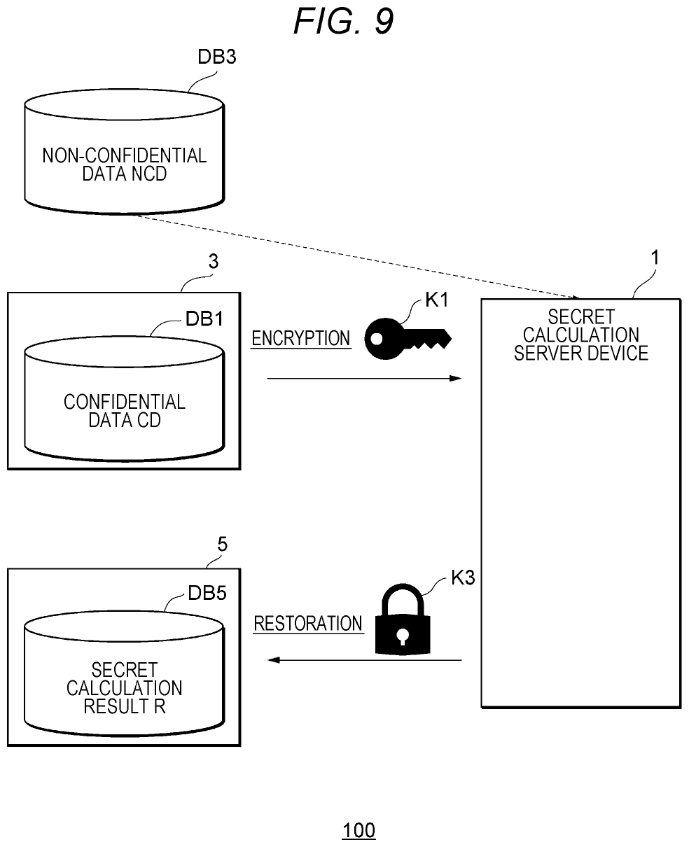

FIG. 9 is a schematic configuration diagram illustrating another example of the secret calculation system according to an embodiment. The secret calculation system 100 illustrated in FIG. 9 executes homomorphic encryption processing. In the homomorphic encryption process, the confidential data supply device 3 encrypts the confidential data CD and transmits the resultant to the secret calculation server device 1 together with an encryption key K1. The secret calculation server device 1 acquires the non-confidential data NCD from the DB3 according to the confidential data CD acquired from the confidential data supply device 3. The secret calculation server device 1 executes the secret calculation in an encrypted state on the basis of the confidential data CD and the non-confidential data NCD. The secret calculation server device 1 transmits a restoration key K3 together with the secret calculation result to the calculation result restoration device 5. The calculation result restoration device 5 restores the secret calculation result R using the restoration key K3. Note that, in FIG. 9, the confidential data supply device 3 and the calculation result restoration device 5 are separate devices, but the two devices may be the same device.

Unlike the secret calculation system 100 illustrated in FIG. 1, the secret calculation system 100 illustrated in FIG. 9 does not require the plurality of secret calculation server devices 1. Therefore, the secret calculation processing for improving the security of the confidential data can be more easily executed.

Note that, as described above, the secret calculation system 100 may be embodied so as to use the secret distribution processing or the homomorphic encryption process as the secret calculation, or may adopt another encryption processing as the secret calculation.

What is claimed is:

1. A secret calculation system that executes secret calculation for calculating data in an encrypted state, the secret calculation system comprising:
a first acquisition unit that acquires first data encrypted;
a second acquisition unit that acquires second data unencrypted according to the first data;
a secret calculation unit that executes the secret calculation on the basis of the first data and the second data; and
an output unit that outputs a result of the secret calculation in an encrypted state.

2. The secret calculation system according to claim 1, further comprising a plurality of server devices, wherein
each of the server devices includes:
a storage unit that stores shares that are fragments of the first data and are generated by secret distribution on the first data;
a secret calculation unit that performs the secret calculation on the basis of the stored shares and the second data; and
an output unit that outputs a result of the secret calculation in an encrypted state.

3. The secret calculation system according to claim 1, wherein
the first data is holding number data related to a holding number of financial products,
the second data is price data related to a price of the financial product, and
the secret calculation unit calculates an appraised value of the financial product on the basis of the holding number data and the price data.

4. The secret calculation system according to claim 3, wherein
the first data includes book value data of the financial product and transaction data indicating a sales amount of the financial product, and
the secret calculation unit calculates trading balance data on the basis of the book value data and the transaction data, and calculates a standard value of the financial product on the basis of the trading balance data calculated and the appraised value calculated.

5. The secret calculation system according to claim 1, wherein
the first data further includes data related to a name of the financial product.

6. The secret calculation system according to claim 1, wherein
the first data includes data related to a holding number of all financial products.

7. A secret calculation method causing a computer to execute secret calculation for calculating data in an encrypted state, the secret calculation method comprising:
acquiring first data encrypted;
acquiring second data unencrypted according to the first data;
executing the secret calculation on the basis of the first data and the second data; and
outputting a result of the secret calculation in an encrypted state.

8. A non-transitory computer-readable recording medium storing a program causing a computer that executes secret calculation for calculating data in an encrypted state to function as:
a first acquisition unit that acquires first data encrypted;
a second acquisition unit that acquires second data unencrypted according to the first data;
a secret calculation unit that executes the secret calculation on the basis of the first data and the second data; and
an output unit that outputs a result of the secret calculation in an encrypted state.
